(19) United States
(12) Patent Application Publication
(10) Pub. No.: US 2022/0371585 A1
(43) Pub. Date: Nov. 24, 2022

(54) CUSTOMIZABLE LANE BIASING FOR AN AUTOMATED VEHICLE

(71) Applicant: Robert Bosch GmbH, Stuttgart (DE)

(72) Inventors: Sean Rumler, Leslie, MI (US); Elizabeth Kao, Northville, MI (US); Christian Sperrle, Ann Arbor, MI (US); Kirthi Duraiswamy, Broadview, MI (US)

(21) Appl. No.: 17/326,459

(22) Filed: May 21, 2021

(51) Int. Cl. B60W 30/12; B60W 40/08; B60W 60/00; G01S 19/42

(52) U.S. Cl. CPC B60W 30/12; B60W 40/08; B60W 60/001; G01S 19/42; B60W 2552/53

(57) ABSTRACT

A method for automated lane keeping includes automatically positioning a vehicle at a normal position in a lane of a roadway with a lane-keeping system of the vehicle, and storing lane-offset data for a predetermined portion of the roadway. The lane-offset data correspond to an offset position of the vehicle in the lane of the roadway that is different from the normal position. The method further includes detecting that the vehicle is operating on the predetermined portion of the roadway, and automatically positioning the vehicle at the offset position with the lane-keeping system when the vehicle is operated on the predetermined portion of the roadway.

### FIELD

This disclosure relates to the field of automated and autonomous vehicles and, in particular, to systems and methods for lane biasing an automated vehicle according to preferences of an operator of the automated vehicle.

### BACKGROUND

Modern on-road vehicles typically include some level of driving automation. SAE International describes the levels of automation ranging from level 0 to level 5. These levels of automation are briefly described herein. A level 0 (SAE 0) vehicle includes no automation, and a level 5 (SAE 5) vehicle has full automation. In vehicles with SAE 0 through level 2 (SAE 2), a human driver monitors the driving environment. In vehicles with level 3 (SAE 3) through SAE 5, an automated driving system monitors the driving environment.

In an exemplary SAE 3 application, a conditionally-automated vehicle includes adaptive cruise control, a lane-keeping system, and an object detection and avoidance system. In this application, the adaptive cruise control maintains the ego-vehicle at a predetermined speed and/or a predetermined distance from a leading vehicle. The lane-keeping system is equipped to keep the ego-vehicle centered in a lane by automatically controlling a steering angle of the ego-vehicle. For example, the lane-keeping system keeps the vehicle in a proper lane for navigating the vehicle from a start point to a destination. The object detection and avoidance system is configured to cause the ego-vehicle to navigate around detected objects and hazards in the roadway. With these systems the operator of the ego-vehicle can enjoy automatic and comfortable transportation.

In known lane-keeping systems, the ego-vehicle is typically maintained at or close to the center of the lane, unless the object detection and avoidance system overrides or takes over control from the lane-keeping system to steer the ego-vehicle around an object or hazard. Navigating the ego-vehicle along the center of the lane makes sense and is comfortable in most situations, but operators may desire to have additional control of the position of the ego-vehicle within the lane. For example, an operator may regularly travel a stretch of road that is safe to traverse in the center of the lane, but that is also safe and more comfortable to traverse with the ego-vehicle biased right of the center of the lane. Each time the operator traverses the stretch of road, the operator must manually steer the ego-vehicle to position the vehicle in the more comfortable and/or the more desirable portion of the road. Accordingly, the operator is forced to regularly take over control of the lane-keeping system and may be dissatisfied with the operation of the known lane-keeping system.

Based on the above, it is desirable to improve automated vehicles so that the ego-vehicle is automatically guided on the roadway in the position that is most comfortable and/or most preferred by the operator.

### SUMMARY

According to an exemplary embodiment of the disclosure, a method for automated lane keeping includes automatically positioning a vehicle at a normal position in a lane of a roadway with a lane-keeping system of the vehicle, and storing lane-offset data for a predetermined portion of the roadway. The lane-offset data correspond to an offset position of the vehicle in the lane of the roadway that is different from the normal position. The method further includes detecting that the vehicle is operating on the predetermined portion of the roadway, and automatically positioning the vehicle at the offset position with the lane-keeping system when the vehicle is operated on the predetermined portion of the roadway.

According to another exemplary embodiment of the disclosure, a driving assistance system for a vehicle includes a lane keeping system, a navigation system, a memory, and a controller. The lane keeping system is configured to (i) navigate the vehicle within a lane of a roadway, and (ii) to generate lane position data corresponding to a position of the vehicle within the lane of the roadway. The navigation system is configured to determine vehicle position data corresponding to a position of the vehicle on Earth. The memory is configured to store the lane position data, the vehicle position data, map data, and lane-offset data. The lane-offset data correspond to an offset position of the vehicle in the lane of a predetermined portion of the roadway. The offset position is different from a normal position of the vehicle in the lane of the roadway. The controller is operably connected to the lane keeping system, the navigation system, and the memory. The controller is configured to automatically position the vehicle at the normal position in the lane of the roadway using the lane-keeping system, and to detect that the vehicle is operating on the predetermined portion of the roadway using the vehicle position data and the map data. The controller is further configured to automatically position the vehicle at the offset position with the lane-keeping system when it is detected that the vehicle is operated on the predetermined portion of the roadway.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is block diagram of a system including a vehicle having a driving assistance system that enables an operator to specify a preferred or customized lane position of the vehicle;

FIG. 2 is a diagram showing a top view of two vehicles on a road, the upper vehicle is not biased within its lane of travel, and the lower vehicle is biased within its lane of travel;

FIG. 3 is a diagram showing a top view of two vehicles on a road, the upper vehicle is controlled within the lane at a normal position along a normal path, and the lower vehicle is controlled within the lane at an offset position along an offset path that deviates from the normal position and the normal path;

FIG. 4 is a flowchart illustrating an exemplary method of operating the vehicle and the driving assistance system of FIG. 1 to offset the vehicle within a lane of travel;

FIG. 5 is a flowchart illustrating an exemplary method of operating the system of FIG. 1 to determine when an operator desires the vehicle to be operated at the offset position within the lane; and

FIG. 6 is a diagram showing a top view of a vehicle on a road, the vehicle is controlled within the lane at an offset position along an offset path.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

Aspects of the disclosure are disclosed in the accompanying description. Alternate embodiments of the disclosure and their equivalents may be devised without parting from the spirit or scope of the disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B and C).

The terms “comprising,” “including,” “having,” and the like, as used with respect to embodiments of the disclosure, are synonymous.

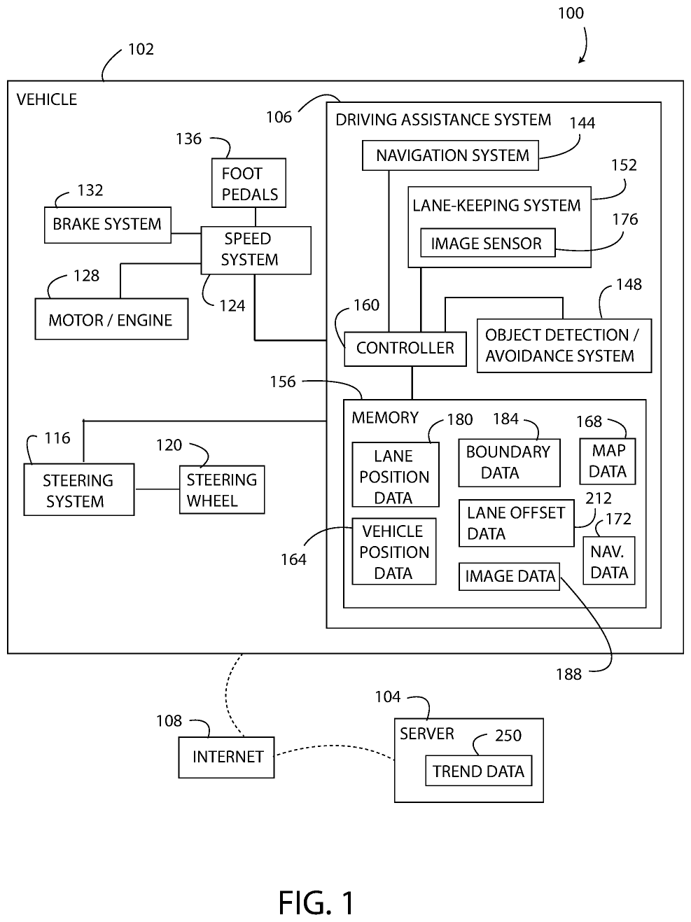

As shown in FIG. 1, a system 100 includes a vehicle 102 and a server 104 operably connected by the Internet 108. The vehicle 102 includes a driving assistance system 106 configured to navigate the vehicle 102. The vehicle 102 is a personal vehicle, a rental car, a shuttle, a limousine, a corporate vehicle, a livery vehicle, a taxi, or semi-trailer truck. The vehicle 102 is any automotive machine suitable for travel on a roadway system, such as public and private roads, highways, and interstates. The vehicle 102, which is also referred to as an ego-vehicle, may have any level of automation from SAE 1 through SAE 5. In an exemplary embodiment, the vehicle 102 is an SAE 3 application having both speed and steering angle automatically controlled by the driving assistance system 106. In other embodiments, the vehicle 102 has any level of automation and/or autonomy that includes automatic steering control. The vehicle 102 is configured to upload data to the server 104 via the Internet 108 and to receive downloaded data from the server 104 via the Internet 108.

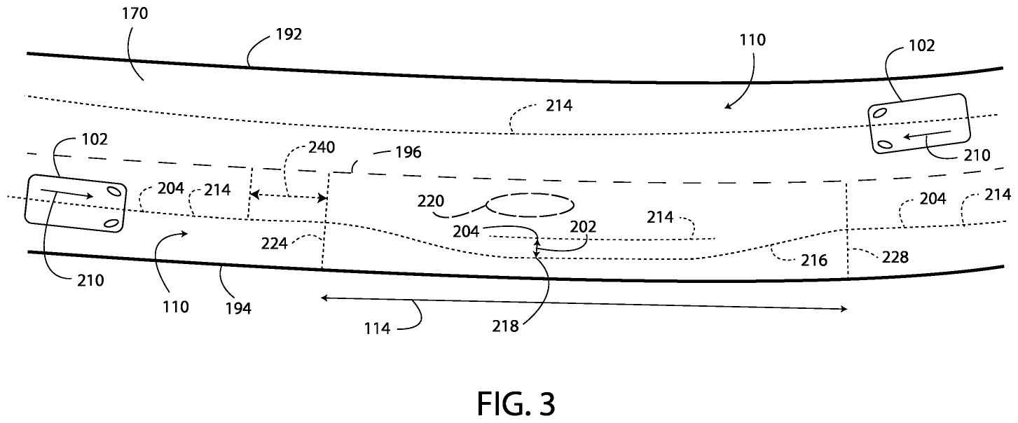

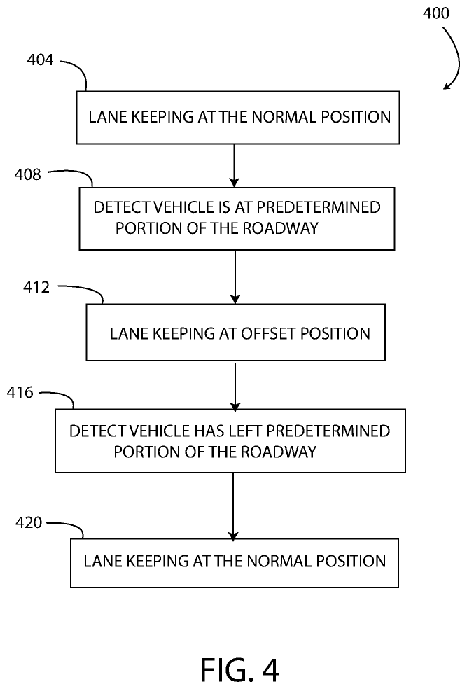

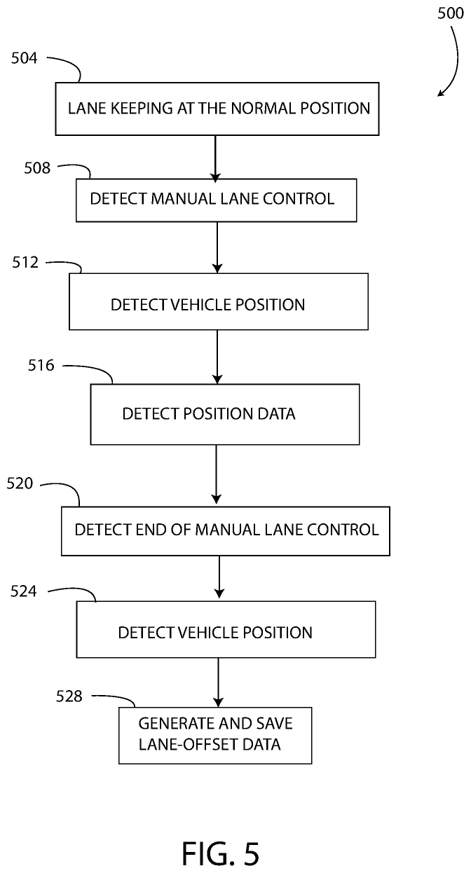

According to this disclosure, the driving assistance system 106 is configured to automatically control a position of the vehicle 102 within a current lane of travel 110 (FIG. 3) according to the preferences of the operator. For example, the driving assistance system 106 detects that the vehicle 102 is located on a predetermined portion 114 of a road/roadway 170 (FIG. 3) and then offsets or biases the position of the vehicle 102 within the lane 110 according to the operator's predetermined preferences. The offset occurs automatically when it is detected that the vehicle 102 has arrived at the predetermined portion 114 of the roadway 170. Accordingly, the vehicle 102 prevents the operator from having to take over control of the driving assistance system 106 each time the vehicle 102 traverses the predetermined portion 114 of the road 170, by automatically biasing the vehicle 102 within the lane 110. The system 100 increases the operator's comfort and increases the amount of time that the position of the vehicle 102 within the lane 110 is automatically controlled. Each element of the vehicle 102, a method 400 (FIG. 4) for controlling the vehicle 102 with the driving assistance system 106, and a method 500 (FIG. 5) of generating lane-offset data 212 are disclosed herein.

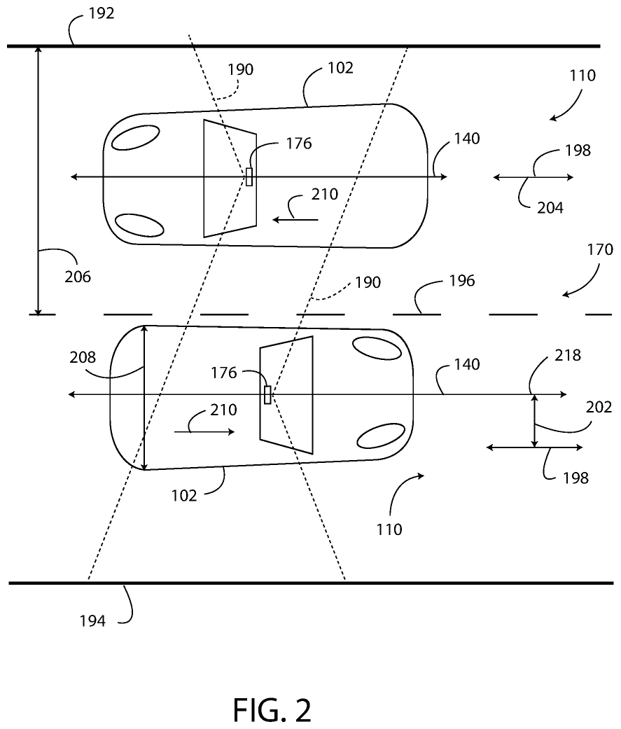

The exemplary vehicle 102 of FIG. 1 includes a steering system 116 and a steering wheel 120, a speed system 124 operably connected to a motor 128, a brake system 132, and foot pedals 136. The steering system 116 is configured control a steering angle of the vehicle 102 so that the vehicle 102 can be automatically and/or manually maneuvered around corners and along roads 170. The steering system 116 moves, pivots, and/or rotates wheels of the vehicle 102 relative to a chassis of the vehicle 102 to steer the vehicle 102. The steering system 116 may be controlled by the driving assistance system 106 so that the steering angle of the vehicle 102 is automatically electronically controlled. The steering system 116 may also be manually controlled by an operator of the vehicle 102 using the steering wheel 120. The steering wheel 120 is also referred to herein as an input device of the vehicle 102 and/or as a human machine interface (HMI) device, and the operator of the vehicle 102 is also referred to as a driver. As used herein, the steering angle of the vehicle 102 is an angle of the wheels of the vehicle 102 relative to a centerline 140 (FIG. 2) of the vehicle 102. In an exemplary embodiment, a positive steering angle causes the vehicle 102 to turn or track left, a zero magnitude steering angle causes the vehicle 102 to track straight, and a negative steering angle causes the vehicle 102 to turn or track right. In one embodiment, when the operator rotates the steering wheel 120 control is taken away from the driving assistance system 106 and is granted to the operator according to an operator takeover.

The motor 128 is configured to generate a drive torque for moving the vehicle 102. In one embodiment, the drive torque is transmitted to the wheels of the vehicle 102 through a transmission. Alternatively, the drive torque is directly transmitted to the wheels, and the vehicle 102 does not include a transmission. In a specific embodiment, the motor 128 is an electric motor supplied with electrical energy from a battery of the vehicle 102. In another embodiment, the motor 128 is an internal combustion engine that burns a fuel for generating the drive torque. The motor 128 may also be a hybrid combination including an electric motor and an internal combustion engine, as is known in the art.

The brake system 132 is configured to generate a braking force for slowing the vehicle 102 and for maintaining the vehicle 102 in a stopped position. The brake system 132, in one embodiment, includes disc brakes that are electrically and/or hydraulically activated. Additionally or alternatively, the brake system 132 includes the motor 128, which is configured to provide regenerative braking and/or dynamic braking.

With reference to FIG. 1, the speed system 124 is configured to automatically control a speed of the vehicle 102. For example, the speed system 124 controls the motor 128 to generate a desired magnitude of the drive torque for moving the vehicle 102 at a desired speed. The speed system 124 may also control the brake system 132 for automatically slowing the vehicle 102 and for automatically bringing the vehicle 102 to a controlled and comfortable stop.

The foot pedals 136 are operably connected to the speed system 136 and are configured to enable an operator of the vehicle 102 to manually control the speed system 124 and to manually control the speed of the vehicle 102. The foot pedals 136 include at least an acceleration pedal for controlling the magnitude of the drive torque of the motor 128, and a brake pedal for selectively activating the brake system 132 for slowing or stopping the vehicle 102. In one embodiment, when the operator operates the foot pedals 136 control is taken away from the driving assistance system 106 and is granted to the operator according to an operator takeover.

As shown in FIG. 1, the driving assistance system 106 includes a navigation system 144, an object detection and avoidance system 148, a lane-keeping system 152, and a memory 156 each operably connected to a controller 160. The navigation system 144 is configured to provide at least vehicle position data 164, map data 168, and navigation data 172 to the controller 160 of the driving assistance system 106. In one embodiment, the navigation system 144 is a satellite navigation system that uses the global positioning system (GPS), the global navigation satellite system (GNSS), and/or any other satellite-based navigation system to generate the vehicle position data 164 from satellite positioning data. The navigation system 144 receives the satellite positioning data from satellites and processes the received data to determine the vehicle position data 164, which corresponds to a position of the vehicle 102 on the Earth. The vehicle position data 164 may be in the format of longitude and latitude and/or any other format.

The map data 168 corresponds to a roadway map of roadways 170 that are available to the vehicle 102. The navigation system 144 is configured to use the vehicle position data 164 to determine the position of the vehicle 102 relative to the map data 168. Accordingly, the navigation system 144 is configured to determine the specific point on the roadway 170 on which the vehicle 102 is currently being operated using the vehicle position data 164 and the map data 168.

The navigation data 172, in an exemplary embodiment, correspond to a route from a starting point to a destination using the available roadways 170 of the map data 168. In one embodiment, the operator of the vehicle 102 configures the navigation system 144 with a desired destination, and the navigation system 144 automatically generates the navigation data 172 for navigating the vehicle 102 to the destination. As described herein, the driving assistance system 106 typically automatically controls the speed of the vehicle 102 using the speed system 124 and the steering angle of the vehicle 102 using the steering system 116 to navigate the vehicle 102 automatically to the destination based on the navigation data 172.

The navigation system 144 is configured to apply data layers to the map data 168 for navigating the vehicle 102. For example, the navigation system 144 may include a digital traffic layer that includes real-time traffic data (not shown). In determining the navigation data 172 for navigating the vehicle 102 to the destination, the navigation system 144 processes the traffic data layer so that the vehicle 102 is navigated using an optimized route that minimizes traffic delays and slowdowns.

The object detection and avoidance system 148 is configured to cause the vehicle 102 to navigate around detected objects and hazards in the roadway 170, as is known in the art. The object detection and avoidance system 148 uses image data from an image sensor, radar data from a radar system, ultrasonic data from an ultrasonic ranging system, and/or LIDAR (light detection and ranging) data from a LIDAR system to detect objects and/or hazards. The detected objects and/or hazards are automatically avoided by the vehicle 102 by automatically controlling the speed of the vehicle 102 with the speed system 124 and/or the steering angle of the vehicle 102 with the steering system 116.

The lane-keeping system 152 includes an image sensor 176 and is configured to generate lane position data 180 and boundary data 184 based on electronic image data 188 from the image sensor 176. The lane-keeping system 152 is configured to perform automated lane keeping for the vehicle 102. As used herein, automated lane keeping refers to automatically controlling the lateral (left and right) and longitudinal (front and back) position of the vehicle 102 within the lane 110 of a roadway 170 and relative to other vehicles on the roadway 170 for an extended time and without operator commands. As shown in FIG. 2, in an exemplary embodiment, the image sensor 176 is a visible-light imaging device mounted on or in the vehicle 102, such that a field of view 190 of the image sensor 176 extends from the front of the vehicle 102. The image sensor 176 is configured to generate the image data 188 corresponding to images of the road 170 ahead of the current position of the vehicle 102 and includes data corresponding to a road edge 192, an opposite road edge 194, and road surface markings 196 that identify the lanes of travel 110, such as the striped line 196. The field of view 190 extends to both road edges 192, 194. Exemplary road surface markings 196 include painted markings dividing and/or identifying lanes of travel 110. In another embodiment, the image sensor 176 is configured as a thermal imaging device configured to generate the image data 188 based on thermal radiation and/or an infrared radiation. In yet another embodiment, the image sensor 176 is a LIDAR (light detection and ranging) system and/or a radar system that is configured to generate the image data 188. The lane-keeping system 152 and the object detection and avoidance system 148 may share the image sensor 176 or the systems 148, 152 may include separate image sensors.

As shown in FIG. 2, the boundary data 184 generated by the lane-keeping system 152 identifies at least the boundaries of the current lane of travel 110 of the vehicle 102. For example, in FIG. 2, the boundary data 184 of the upper vehicle 102 identifies the striped line 196 (a left boundary) and the road edge 192 (a right boundary) as the boundary data 184. The boundary data 184 of the lower vehicle 102 in FIG. 2 is identified as the striped line 196 (a left boundary) and the road edge 184 (a right boundary).

With reference to FIG. 2, the lane-keeping system 152 is configured to determine a center 198 of the current lane of travel 110 by processing the boundary data 184. For example, in FIG. 2, for the lower vehicle 102, the center 198 of the current lane of travel 110 is determined as a midpoint between the stripped line 196 and the road edge 194. In other embodiments, the road 170 does not include road surface markings 196, such as on typical two-way residential streets. In such an embodiment, the center 198 of the current lane of travel 110 is determined by first identifying a road midpoint between the detected road edges 192, 194. Then, using the road midpoint and the nearest road edge 192, 194, the lane-keeping system 152 identifies the center 198 of the lane 110 as halfway between the road midpoint and the nearest road edge 192, 194. In yet another embodiment, on a multilane road having multiple sets of the striped lines 196, the lane of travel 110 is defined on both sides by the striped line 196 and the center 198 is halfway between the striped lines 196 defining the lane 110. The lane-keeping system 152 may use any other process to identify the center 198 of the current lane of travel 110.

The lane position data 180 generated by the lane-keeping system 152 correspond to a distance of the centerline 140 of the vehicle 102 from the center 198 of the lane 110. The centerline 140 is parallel to a direction of travel 210 of the vehicle 102. The lane position data 180 are a measure of an offset 202 (FIG. 2) of the vehicle 102 and/or an offset distance of the vehicle 102. As used herein, the vehicle 102 is biased away from the center 198 of the lane 110 when the offset 202 is non-zero. As shown in FIG. 2, the upper vehicle 102 is navigating the lane 110 with the centerline 140 aligned with the center 198 of the lane 110, such that there is no offset 202 or zero offset 202. Accordingly, the position data 180 for the upper vehicle 102 are zero and/or correspond to zero distance between the centerline 140 and the center 198 of the lane 110. The upper vehicle 102 is not biased from the center 198 of the lane 110 and is referred as being at a normal position 204 in the lane 110. In one embodiment, the normal position 204 of the vehicle 102 in the lane 110 corresponds to the centerline 140 of the vehicle 102 being aligned or substantially aligned with the center 198 of the lane 110. Substantially aligned with the center 198 of the lane 110 includes positioning the centerline 140 of the vehicle 102 within 5% of a total width 206 of the lane 110 from the center 198 of the lane 110. The normal position 204 is the position of the vehicle 102 within the lane 110 when no obstacles or hazards are present (as detected by the obstacle detection and avoidance system 148) and no lane-offset data 212 is associated with that portion of the roadway 170. The normal position 204 is not offset relative to the center 198 of the lane 110. The normal position 204 is also referred to herein as a default position.

Whereas, the lower vehicle 102 of FIG. 2 is biased towards the stripped line 196 (the left boundary) with a non-zero offset 202. For example, in FIG. 2, the lower vehicle 102 has position data 180 corresponding to an offset 202 of from thirty centimeters (30 cm) to one meter (1 m) away from the center 198 of the lane 110. The offset 202 may be on either side of the center 198 of the lane 110. When the vehicle 102 is biased with the offset 202, the centerline 140 of the vehicle 102 is spaced apart from the center 198 of the current lane of travel 110.

The lane-keeping system 152 is configured to limit the offset 202, such that no portion of the vehicle 102 is located outside of boundaries of the lane 110, as determined by the boundary data 184. That is, when the vehicle 102 is biased with the offset 202, no portion of the vehicle 102 is located outside of the left boundary and the right boundary.

The controller 160 of the driving assistance system 106 is configured to automatically control the steering angle and the speed of the vehicle 102 based on at least the vehicle position data 164, the map data 168, the navigation data 172, the lane position data 180, and the boundary data 184. The controller 160 is provided as at least one microcontroller and/or microprocessor. For example, the controller 160 is configured to control the steering system 116 to automatically offset the vehicle 102 away from the center 198 of the lane 110 on the predetermined portion 114 of the roadway 170 (FIG. 3). The controller 160 is also configured to control the speed of the vehicle 102 by controlling the drive torque of the motor 128 and by controlling the brake system 132. In certain SAE levels, such as SAE 3 through SAE 5, the driving assistance system 106 navigates the vehicle 102 based on data from other sensors and systems, such as the object detection and avoidance system 148.

The controller 160 of the driving assistance system 106 is also configured to generate the lane-offset data 212 and to operate the vehicle 102 according to the lane-offset data 212. As shown in FIG. 3, the driving assistance system 106 is automatically navigating the upper vehicle 102 in the normal position 204 along a normal path 214 within the lane 110 of the roadway 170 using the lane-keeping system 152. The normal path 214 is also referred to herein as a default path. When the vehicle 102 is navigated or guided on the normal path 214 by the driving assistance system 106, the vehicle 102 is maintained in the normal position 204. The upper vehicle 102 is not operated according to the lane-offset data 212.

The lower vehicle 102 in FIG. 3 is navigated according to the lane-offset data 212 along an offset path 216 at the predetermined portion 114 of the roadway 170. The lane-offset data 212 corresponds to a biased or an offset position 218 of the vehicle 102 in the lane 110 of the roadway 170 that is different from the normal position 204. In the offset position 218, the centerline 140 of the vehicle 102 is spaced apart from the center 198 of the lane 110. For example, in FIG. 3 the lane-offset data 212 correspond to an offset 202 that causes the vehicle 102 to avoid the roadway feature 220. The roadway feature 220 may be a pothole, an uneven section of the road 170, a bump, a dip, or any other feature that the operator desires to avoid. Typically, however, it would be safe for the vehicle 102 to traverse the roadway feature 220 at the normal position 204, but the operator is more comfortable when the vehicle 102 does not traverse the roadway feature 220. The offset 202 is biased away from the normal position 204 within the lane of travel 110. The lane-offset data 212 includes, for example, steering angle information that is provided to the steering system 116 for causing the vehicle 102 to track along the offset path 216 to the offset position 218. The lane-offset data 212 also includes data corresponding to a beginning point 224 and an end point 228 of the predetermined portion 114 of the roadway 170. Thus, the lane-offset data 212 include data identifying the location of the predetermined portion 114 of the roadway 170, and data identifying the offset 202, the offset path 216, and the offset position 218 at the predetermined portion 114 of the roadway 170. Further discussion of the lane offset data 212 is included herein.

The memory 156 is a non-transitory computer readable storage medium that is configured to store at least the vehicle position data 164, the map data 168, the navigation data 172, the lane position data 180, the boundary data 184, the image data 188, the lane-offset data 212, and any other data used to operate the driving assistance system 106 of the vehicle 102.

In one embodiment, the lane-offset data 212 is stored in the memory 156 as a customizable offset layer that is applied to the map data 168 similarly to how the traffic data layer is applied to the map data 168. Specifically, each of the predetermined portions 114 of the roadways 170 identified in the lane-offset data 212 are applied to the map data 168 so that each time the vehicle 102 navigates one of the predetermined portions 114, the vehicle 102 is offset on a corresponding offset path 216, as desired by the operator.

As shown in FIG. 1, the vehicle 102 is operably connected to the server 104 to wirelessly receive data from the server 104 and to wirelessly transmit data to the server 104 via the Internet 108. The server 104 includes or is configured as a computer to process data and to generate data. For example, in an embodiment as described herein, the server 104 generates trend data 250 by processing the lane-offset data 212 received from a plurality of the vehicles 102.

An exemplary method 400 for automated lane keeping is shown in FIG. 4 and is described with reference to FIG. 3. At block 404, the method 400 includes using the lane-keeping system 152 to automatically position the vehicle 102 at the normal position 204 along the normal path 214 in the lane 110 of the roadway 170. In particular, at block 404, the vehicle 102 is typically guided along the center 198 (FIG. 2) of the lane 110 prior to arriving at the beginning point 224. The driving assistance system 106 uses the lane position data 180 and the boundary data 184 generated from the image data 188 to determine the center 198 and to keep the vehicle 102 on the normal path 214.

Next, at block 408 of the method 400, the driving assistance system 106 detects that the vehicle 102 is operating on the predetermined portion 114 of the roadway 170. When the vehicle 102 is in motion, the controller 160 compares the current position of the vehicle 102 to the position of the beginning point 224 to determine if the vehicle 102 is operated on one of the predetermined portions 114 of the roadway 170. The current position of the vehicle 102 is included in the vehicle position data 164. The driving assistance system 106 determines that the vehicle 102 is at the beginning point 224, when the vehicle position data 164 is within a predetermined distance 240 of the beginning point 224. In an example, the predetermined distance 240 is from twenty-five meters (25 m) to fifty meters (50 m). In other embodiments, the predetermined distance 240 is from five meters (5 m) to one hundred meters (100 m). The magnitude of the predetermined distance 240 depends on the typical speed of the vehicle 102 when traveling on the roadway 170, with high speeds corresponding to a greater magnitude of the predetermined distance 240 and with lower speeds corresponding to a lower magnitude of the predetermined distance 240.

As indicated in FIG. 3, the predetermined portion 114 of the roadway 170 is only the lower lane 110 of the roadway 170. The upper lane 110 of the roadway 170 is not included in the predetermined portion 114 of the roadway 170. The lower lane 110 of the roadway 170 is the portion 114 of the roadway 170 that includes corresponding lane-offset data 212. The driving assistance system 106 determines the direction of travel 210 of the vehicle 102 to assist identifying the lane 110 in which the vehicle 102 is operated. For example, in the two-lane roadway 170 of FIG. 3, when the direction of travel 210 is to the right, the vehicle 102 is in the lower lane 110 and the vehicle 102 passes through the predetermined portion 114 of the roadway 170. When, however, direction of travel 210 is to the left in FIG. 3, the vehicle 102 is in the upper lane 110 and the vehicle 102 does not pass though the predetermined portion 114 of the roadway 170. Any other system or process may be used to determine the lane 110 in which the vehicle 102 is being operated.

At block 412 of the method 400, the driving assistance system 106 uses the lane-keeping system 152 to automatically position the vehicle at the offset position 218 along the offset path 216 when the vehicle 102 is operated on the predetermined portion 114 of the roadway 170. Positioning the vehicle 102 at the offset position 218 includes smoothly guiding the vehicle 102 from the normal position 204 to the offset position 218 typically along the offset path 216. When the vehicle 102 is operated on the offset path 216, the centerline 140 of the vehicle 102 is usually spaced apart from the center 198 of the lane 110. When operating on the offset path 216, however, the centerline 140 of the vehicle 102 may cross from one side of the center 198 to the other or may briefly track along the center 198 when maneuvering among multiple roadway features 220 of the predetermined portion 114 of the roadway 170.

As shown in FIG. 3, when the vehicle 102 crosses the beginning point 224 and enters the predetermined portion 114 of the roadway 170, the lane-keeping system 152 controls the steering system 116 to bias the vehicle 102 with the offset 202 along the offset path 216 to the offset position 218 in order to avoid the roadway feature 220. The offset position 218 is offset from the normal position 204 by the offset 202, such that the offset position 218 is different from the normal position 204. A portion of the normal path 214 is shown near the roadway feature 220 for comparison to the offset path 216, but the vehicle 102 is not operated on the normal path 214 through the predetermined portion 114 of the roadway 170. The automatic steering causes the vehicle 102 to traverse the lane 110 in a position that is more comfortable and/or more preferred than the normal path 214. For example, if the roadway feature 220 is a pothole, the lane-offset data 212 cause the vehicle 102 to automatically steer to the right of the pothole 220 so that the vehicle 102 tires do not tread through the pothole 220 and instead the vehicle 102 traverses a smoother portion of the lane 110 of the predetermined portion 114 of the roadway 170. No operator involvement is required for biasing the vehicle 102 to the offset position 218 along the offset path 216, and the operator's preference for avoiding the roadway feature 220 is automatically applied. Thus, the method 400 increases operator comfort and convenience and prevents a driver takeover of the steering system 116.

Next, at block 416 of the method 400, the driving assistance system 106 detects that the vehicle 102 has left the predetermined portion 114 of the roadway 170. In particular, when the vehicle 102 is in motion, the controller 160 compares the current position of the vehicle 102 to the position of the end point 228 to determine if the vehicle 102 is no longer operated on the predetermined portion 114 of the roadway 170. The current position of the vehicle 102 is included in the vehicle position data 164. When the controller 160 determines that the vehicle 102 has moved past the end point 228, then the controller 160 determines that the vehicle 102 is no longer operated on the predetermined portion 114 of the roadway 170.

At block 420, when the vehicle position data 164 indicates that the vehicle 102 is no longer operated on the predetermined portion 114 of the roadway 170, the driving assistance system 106 uses the lane-keeping system 152 to automatically position the vehicle 102 at the normal position 204 along the normal path 214. In FIG. 3, shortly after passing end point 228, the vehicle 102 returns to the normal position 204 on the normal path 214, as controlled by the lane-keeping system 152. The lane position of the vehicle 102 is controlled by the lane-keeping system 152 until the vehicle 102 is navigated to another predetermined portion 114 of the roadway 170, the operator performs a takeover of the steering system 116 or the speed system 124, or until an obstacle or hazard is detected by the object detection/avoidance system 148.

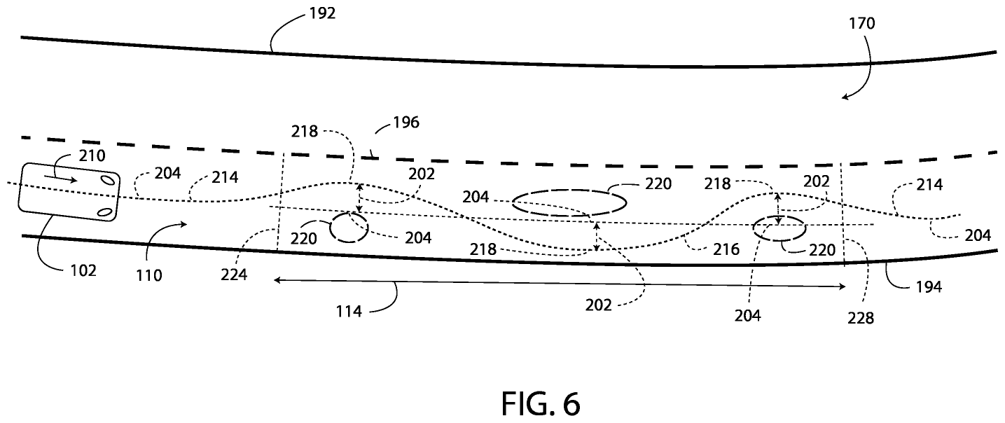

With reference to FIG. 5, a method 500 of generating the lane-offset data 212 is shown and is described with reference to FIG. 6. At block 504, the lane-keeping system 152 is used to automatically position the vehicle 102 at the normal position 204 along the normal path 214 prior to the beginning point 224. In some embodiments, at block 504, the vehicle 104 is automatically navigated according to the map data 168 from a start point to a destination point. Automatically navigating the vehicle 102 includes automatically controlling the steering angle and the speed of the vehicle 102 and automatically causing the vehicle 102 to comply with traffic signals, signs, rules, and regulations while moving from the start point to the destination on the roadway 170. In other embodiments at block 504, the lane position of the vehicle 102 is controlled by the lane-keeping system 152, but the vehicle 102 is not being actively guided to a particular destination. For example, the driving assistance system 106 may be activated by the operator to maintain a particular lane 110 on a highway or interstate.

Next, at block 508 of the method 500, the driving assistance system 106 detects that the operator has started manual lane control. Manual lane control occurs when the operator/driver controls the position of the vehicle 102 within the lane 110, typically by using the steering wheel 120. Specifically, at the beginning point 224, the operator takes control from the driving assistance system 106 by rotating the steering wheel 120 to the left to avoid the first roadway feature 220. Then, the operator rotates the steering wheel 120 to the right to avoid the second roadway feature 220. Next, the operator rotates the steering wheel 120 to the left again to avoid the third roadway feature 220. The manual lane control is detected by monitoring operator inputs to steering wheel 120. In particular, when the operator rotates the steering wheel 120, the lane-keeping system 152 is automatically disabled, and the driving assistance system 106 monitors and saves data corresponding to the position and/or the angle of the steering wheel 120 as the operator maneuvers the vehicle 102 through the predetermined portion 114 of the roadway 170.

At block 512 of the method 500, the driving assistance system 106 detects the vehicle 102 position during the manual lane control. In particular, when the manual lane control begins, the driving assistance system 106 detects the current position of the vehicle 102 on the Earth using the vehicle position data 164 from the navigation system 144 and also determines the particular roadway 170 on which the vehicle 102 is operated using the map data 168. The position detected at block 512 from the vehicle position data 164 and the map data 168 is saved as the beginning point 224 of the predetermined portion 114 of the roadway 170 in the lane-offset data 212.

Next, at block 516 of the method 500, during the manual lane control the driving assistance system 106 detects the position of the vehicle 102 within the lane 110. Specifically, the driving assistance system 106 uses the lane position data 180 and the data from the steering system 116 to identify and to record the offset position 218 resulting in the offset path 216 as the lane-offset data 212. In this way, the steering wheel 120 operates as an HMI or an input device used by the operator to ultimately generate the lane-offset data 212 that corresponds to a customized path through the predetermined portion 114 of the roadway 170 to avoid one or more roadway features 220. That is, the steering angle as set by the rotational position of the steering wheel 120 is detected by the driving assistance system 106 and is used along with the vehicle position data 164, the lane position data 180, the boundary data 184, and the map data 168 to arrive at the lane-offset data 212. In other embodiments, the operator uses any other type of HMI or input device included in the vehicle 102 to cause the driving assistance system 106 to generate the lane-offset data 212, such as a touchscreen, a joystick, a microphone to receive voice commands, physical buttons, and/or a portable computer device operably connected to the vehicle 102, such as a smartphone or a laptop computer.

At block 520 of the method 500, the driving assistance system 106 detects that the operator of the vehicle 102 has stopped manual lane control. In one embodiment, the end of the manual lane control is detected when operator re-engages the lane-keeping system 152. In another embodiment, the end of the manual lane control is detected automatically when the operator returns the vehicle 102 to the normal position 204 for a predetermined time period. An exemplary predetermined time period is from five seconds (5 s) to fifteen seconds (15 s). The operator may also use an input device of the vehicle 102 to signal that the manual lane control has ended.

Next, at block 524 of the method 500, the driving assistance system 106 detects the vehicle position at the end of the manual lane control. In particular, when the end of the manual lane control is detected, the driving assistance system 106 detects the current position of the vehicle 102 on the Earth using the vehicle position data 164 from the navigation system 144 and also confirms the roadway 170 on which the vehicle 102 is operated using the map data 168. The position detected at block 524 is saved as the end point 228 of the predetermined portion 114 of the roadway 170 in the lane-offset data 212.

At block 528, the driving assistance system 106 stores the offset positions 218 manually taken by the operator, the beginning point 224, and the end point 228, as additional lane-offset data 212 in the memory 156. That is, the driving assistance system 106 generates the lane-offset data 212 based on the position of the vehicle 102 in the lane 110 during the detected manual lane control.

With the additional lane-offset data 212 stored in the memory 156, the next time that the operator navigates the roadway of FIG. 6 in the lower lane 110, the driving assistance system 106 will apply the method 400 of FIG. 4, and the vehicle 102 will be automatically controlled to avoid the first, second, and third roadway features 220. Thus, the operator has created a customized permanent offset 202 for the predetermined portion 114 of roadway 170 that will be automatically performed by the driving assistance system 106. The driving assistance system 106 applies the offset 202 from the lane-offset data 212 regardless of the destination of the operator. That is, the offset 202 from the lane-offset data 212 is applied each time the vehicle 102 navigates the predetermined portion 114 of the roadway 170. By using the steering wheel 120 or any other vehicle input device, the operator customizes, builds, and adds to the lane-offset data 212, so that the next time the vehicle 102 navigates the lane 110, the vehicle 102 takes a customized and comfortable path 216 that prevents the operator from taking over control of the steering system 116 and that enables the operator to allow the driving assistance system 106 to control the position of the vehicle 102 within the lane 110.

In another embodiment, the lane-offset data 212 from a first vehicle 102 is used to control the lane position of other vehicles 102 in addition to the first vehicle 102. For example, and with reference to FIG. 3, a plurality of vehicles 102 may independently have operators that manually control a corresponding one of the vehicles 102 to generate the lane-offset data 212 for avoiding the same roadway feature 220. The lane-offset data 212 from the plurality of vehicles 102 is uploaded to the server 104 using the Internet 108 according to known data transmission techniques and protocols. The server 104 automatically processes the uploaded lane-offset data 212 from the multiple vehicles 102 to determine lane positioning trend data 250. Trends in the lane positioning trend data 250 are identified when a predetermined number of vehicles 102 generate similar lane-offset data 212 for a particular predetermined portion 114 of a roadway 170. That is, the server 104 processes the uploaded data for similarities in the lane-offset data 212 that tend to show that operators are avoiding a particular roadway feature(s) 220 on a particular predetermined portion 114 of the roadway 170. When similarities in the data are detected, a trend is identified and saved as the trend data 250.

When lane positioning trend data 250 is identified by the server 104, the trend data 250 is provided to other vehicles and is saved in a memory of the other vehicles as the lane-offset data 212. The trend data 250 may be provided as an over-the-air (OTA) download to the other vehicles, for example. The vehicles are then operated based on the lane positioning trend data 250, such that the other vehicles are biased to a corresponding offset position 218 when it is determined that the other vehicles are on a corresponding predetermined portion 114 of a roadway 170. In this way, the lane-offset data 212 generated from a first vehicle is applied to a second vehicle that did not independently generate the lane-offset data 212. The lane positioning trend data 250 increases the comfort and convenience of the operator of the vehicle by causing the vehicle to automatically the avoid the roadway feature 220.

Based on the above, the vehicle 102 and the driving assistance system 106 create an additional customizable offset layer to the map data 168 and allow the driver, via HMI, to add a permanent offset to a particular lane segment 114 that is saved to the lane-offset data 212. The next time that the vehicle 102 drives on that lane segment 114, regardless of the destination, the vehicle 102 uses the lane-offset data 212 to offset the vehicle 102. The features of the vehicle 102 and the driving assistance system 106 disclosed herein allow the operator to customize a path through commonly driven roadways 170 to give them a more comfortable driving experience, and a feeling of more control over the autonomous/automated system 100. When the lane-offset data 212 is uploaded to the server 104 and mined for the trend data 250, the system 100 aids in the development of a more universal lane biasing method.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for automated lane keeping comprising:
automatically positioning a vehicle at a normal position in a lane of a roadway with a lane-keeping system of the vehicle;
storing lane-offset data for a predetermined portion of the roadway, the lane-offset data corresponding to an offset position of the vehicle in the lane of the roadway that is different from the normal position;
detecting that the vehicle is operating on the predetermined portion of the roadway; and
automatically positioning the vehicle at the offset position with the lane-keeping system when the vehicle is operated on the predetermined portion of the roadway.

2. The method for automated lane keeping as claimed in claim 1, further comprising:
detecting that the vehicle has left the predetermined portion of the roadway; and
automatically positioning the vehicle at the normal position with the lane-keeping system when the vehicle has left the predetermined portion of the roadway.

3. The method for automated lane keeping as claimed in claim 1, wherein:
the vehicle includes an input device, and
an operator of the vehicle uses the input device to generate the lane-offset data.

4. The method for automated lane keeping as claimed in claim 1, further comprising:
detecting that an operator of the vehicle has started manual lane control of the vehicle at the predetermined portion of the roadway, the vehicle moved to the offset position during the manual lane control;
detecting that the operator of the vehicle has stopped manual lane control of the vehicle; and
generating the lane-offset data based on a position of the vehicle in the lane during the manual lane control.

5. The method for automated lane keeping as claimed in claim 4, further comprising:
detecting that the operator of the vehicle has started manual lane control by monitoring a position of a steering wheel of the vehicle.

6. The method for automated lane keeping as claimed in claim 1, wherein:
the vehicle defines a centerline in a direction of travel,
the centerline is aligned with a center of the lane in the normal position, and
the centerline is spaced apart from the center of the lane in the offset position.

7. The method for automated lane keeping as claimed in claim 1, wherein:
the vehicle defines a centerline in a direction of travel,
the centerline is aligned with a center of the lane in the normal position, and
the vehicle is moved within the lane to the left and to the right of the center of the lane in the offset position.

8. The method for automated lane keeping as claimed in claim 1, wherein detecting that the vehicle is operating on the predetermined portion of the roadway comprises:
detecting a beginning point and an end point of the predetermined portion of the roadway using satellite positioning data and map data corresponding to a roadway map.

9. The method for automated lane keeping as claimed in claim 1, further comprising:
automatically navigating the vehicle according to map data that corresponds to a roadway map,
wherein the lane-offset data is stored as a customizable offset layer applied to the map data.

10. The method for automated lane keeping as claimed in claim 1, wherein the vehicle is included in a plurality of vehicles, the method further comprising:
generating the lane-offset data with the plurality of vehicles for the predetermined portion of the roadway;
uploading the lane-offset data from each corresponding vehicle to a server;
automatically processing the uploaded lane-offset data to determine lane positioning trend data;
providing the lane positioning trend data to another vehicle not included in the plurality of vehicles; and
operating the other vehicle based on the lane positioning trend data, such that the other vehicle is moved to the offset position when it is determined that the other vehicle is operated on the predetermined portion of the roadway.

11. A driving assistance system for a vehicle comprising:
a lane keeping system configured to (i) navigate the vehicle within a lane of a roadway, and (ii) to generate lane position data corresponding to a position of the vehicle within the lane of the roadway;
a navigation system configured to determine vehicle position data corresponding to a position of the vehicle on Earth;
a memory configured to store the lane position data, the vehicle position data, map data, and lane-offset data, the lane-offset data corresponding to an offset position of the vehicle in the lane of a predetermined portion of the roadway, the offset position different from a normal position of the vehicle in the lane of the roadway; and
a controller operably connected to the lane keeping system, the navigation system, and the memory, the controller configured to:
automatically position the vehicle at the normal position in the lane of the roadway using the lane-keeping system;
detect that the vehicle is operating on the predetermined portion of the roadway using the vehicle position data and the map data; and
automatically position the vehicle at the offset position with the lane-keeping system when it is detected that the vehicle is operated on the predetermined portion of the roadway.

12. The driving assistance system as claimed in claim 11, wherein the controller is further configured to:
detect that the vehicle has left the predetermined portion of the roadway using the vehicle position data and the map data; and
automatically position the vehicle at the normal position with the lane-keeping system when the vehicle has left the predetermined portion of the roadway.

13. The driving assistance system as claimed in claim 11, wherein the controller is further configured to:
detect that an operator of the vehicle has started manual lane control of the vehicle at the predetermined portion of the roadway, the vehicle moved to the offset position during the manual lane control;
detect that the operator of the vehicle has stopped manual lane control of the vehicle; and
generate the lane-offset data based on lane position data corresponding to a position of the vehicle in the lane during the manual lane control.

14. The driving assistance system as claimed in claim 13, wherein the controller is further configured to:
detect that the operator of the vehicle has started manual lane control by monitoring a position of a steering wheel of the vehicle.

15. The driving assistance system as claimed in claim 11, wherein the controller is configured to detect that the vehicle is operating on the predetermined portion of the roadway by detecting a beginning point and an end point of the predetermined portion of the roadway using the vehicle position data and the map data.

16. The driving assistance system as claimed in claim 11, wherein the navigation system is configured to determine the vehicle position data based on received satellite navigation signals.
